(19) United States
(12) Patent Application Publication
(10) Pub. No.: US 2007/0204811 A1
(43) Pub. Date: Sep. 6, 2007

(54) Therapeutic pet collar

(76) Inventor: George S. Agee, Dayton, OH (US)

Correspondence Address: LITMAN LAW OFFICES, LTD., P.O. BOX 15035, CRYSTAL CITY STATION, ARLINGTON, VA, 22215, US

(21) Appl. No.: 11/702,184

(22) Filed: Feb. 5, 2007

Related U.S. Application Data
(60) Provisional application No. 60/778,934, filed on Mar. 6, 2006.

(51) Int. Cl. A01K 27/00

(52) U.S. Cl. 119/860

(57) ABSTRACT

The therapeutic pet collar is an iron, nickel or alloy chain collar having thin copper electroplating. The iron, nickel or alloy conducts magnetic fields. Resultant currents may have beneficial effects on an animal wearing the collar. Link metal construction is strong enough to help restrain a pet, if necessary. A resilient plug magnet holder may be inserted into a link, twisted and locked in place to hold magnets inside a link of the chain. A plurality of magnets may be attached to the collar and disposed so that their polarities alternate respectively. Alternatively, the collar may be made from nylon, leather or a combination of cloth type materials. A copper line is braided in a crisscross pattern that spans approximately ¾ of the collar length. Magnets are staggered on the copper line on the inside of the collar facing perpendicular to the pet's skin so that their polarities alternate respectively.

### CROSS-REFERENCE TO RELATED APPLICATION

This application claims the benefit of U.S. Provisional Patent Application Ser. No. 60/778,934, filed Mar. 6, 2006.

### BACKGROUND OF THE INVENTION

1. Field of the Invention

The present invention relates to therapeutic devices. More specifically, it relates to a magnetic therapeutic animal restraint.

2. Description of the Related Art

Selective placement of magnets on humans and animals has long been recognized as having some therapeutic effects on the treatment of various ailments such as arthritis and circulatory problems. While various magnet therapy collars have been developed, there still exists the problem that very little attention has been paid to orientation of fields and currents generated by these collars.

Another problem associated with existing pet collars is the inability of the user to easily remove the magnets completely from, or change the orientation, strength and location of magnets on, the animal restraint. This problem disadvantageously results in a pet owner having to buy different collars for different therapy regimens.

Thus, a therapeutic pet collar solving the aforementioned problems is desired.

### SUMMARY OF THE INVENTION

The therapeutic pet collar may be an iron or alloy chain collar that can include a thin copper electroplating. The iron or alloy conducts magnetic fields. Resultant currents flowing through the links, as well as the magnetic fields, may have a beneficial effect on an animal wearing the collar. Link metal construction is strong enough to help restrain a pet, if necessary. A resilient plug magnet holder may be inserted into a link, twisted, and locked in place to hold magnets inside a link of chain. A plurality of magnets may be attached to the collar and disposed so that their polarities alternate, respectively. Alternatively, the collar may be made from nonconductive materials, such as nylon, leather, cloth, and the like. A copper line is braided in a crisscross pattern over and under the collar material so that the pattern spans approximately three-quarters of the collar length. Magnets are placed staggered on the copper line on the inside of the collar facing perpendicular to the pet's skin so that their polarities alternate, respectively.

These and other features of the present invention will become readily apparent upon further review of the following specification and drawings.

### BRIEF DESCRIPTION OF THE DRAWINGS

FIG. 1 is an environmental, perspective view of a therapeutic pet collar according to the present invention.

FIG. 2 is a top view of the chain type therapeutic pet collar according to the present invention.

FIG. 3 is an enlarged, fragmented sectional top view of the chain type therapeutic pet collar according to the present invention.

FIG. 4 is a top view of an alternative embodiment of a therapeutic pet collar according to the present invention.

FIG. 5 is a side view of a therapeutic necklace according to the present invention.

Similar reference characters denote corresponding features consistently throughout the attached drawings.

### DETAILED DESCRIPTION OF THE PREFERRED EMBODIMENTS

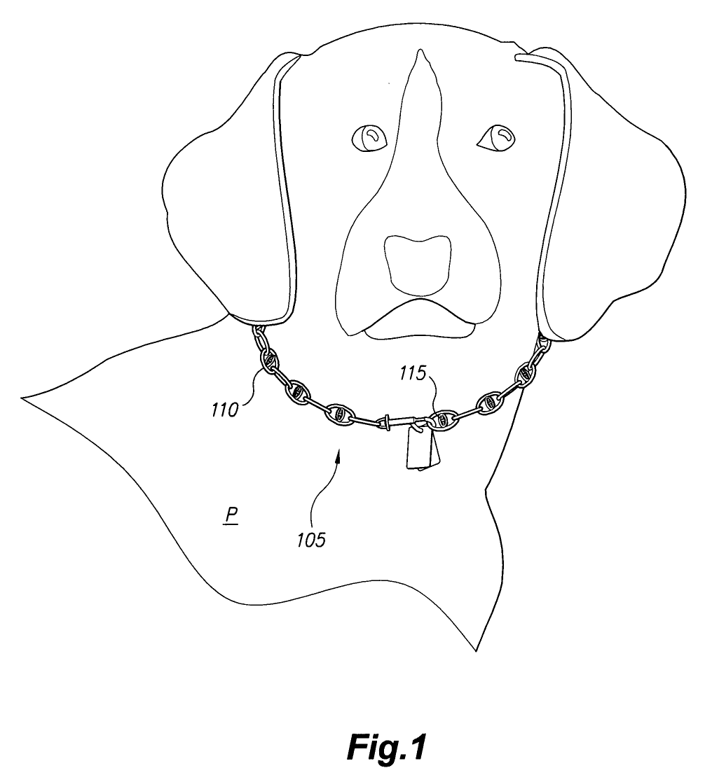

As shown in FIG. 1, the present invention is a therapeutic collar 105 having plug-like magnet inserts 115 attached to chain links 110. Collar 105 may be composed of iron, or alloy, such as steel, or any other ferromagnetic metal, such as a nickel base metal, and may, preferably, as shown in FIG. 3, have an approximately 1/64^{th} inch layer of copper electroplating 310. The iron, nickel, or other alloy, such as steel, or other ferromagnetic metal in the therapeutic collar 105 is a conductor of magnetic fields and, according to the present invention, may provide the capability to assist in toxin release and blood flow of a pet, animal, or even human when worn around the neck.

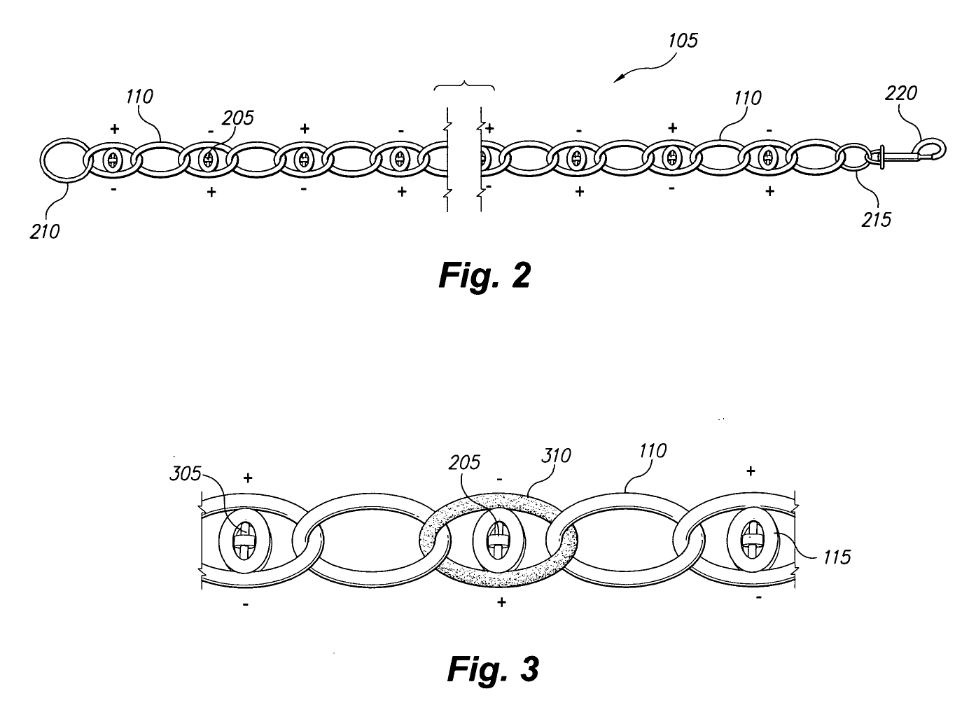

The copper electroplating 310 is provided to potentially enhance joint movements, improve blood circulation and relieve the pain of arthritis. Additionally, the copper electroplating 310 may assist in the flow of small electrical currents around each link 110 of the therapeutic collar 105, the electrical currents being induced by motion of the magnets 205 as the wearer, such as pet P, moves about. Chain links 110 of the collar 105 may be approximately ½ inch wide and may vary in length by approximately ⅝ inch. The link metal is strong enough to help restrain a pet, such as pet P, if necessary. As shown in FIG. 2, one end of the collar 105 has a large circular metal ring 210. A spring-forced clasp 220 is attached to a ring, such as ring 215 and may be utilized to adjust the length of the collar 105. Additionally, ring 215 is of sufficiently small dimension to slip through ring 210 so that the collar 105 may be used as a choke chain for further enhancement of restraint of pet P.

Magnets 205 are preferably ring-type, having a hollow cylindrical shape that provides an axial hole through which the magnets 205 may be attached to inserts 115 or chain links 110. For example, a copper axle 305 may be disposed through the axial hole of magnet 205 while opposing ends of the copper axle 305 are securely attached to the magnetic insert 115. Preferably each magnet 205 has a residual flux density rating in the range of 12-13 thousand Gauss (KGs), although it is within the scope of the present invention to provide less powerful or more powerful magnets in the therapeutic collar 105, depending on a particular use or application, i.e., use on a smaller animal or use on a larger animal.

Magnets 205 may be attached inside chain link 110 perpendicular to the body of the wearer, such as pet P, so that both magnetic polarities are proximate the wearer. Each magnet may be placed in the same pole position from one end of the collar 105 to the next. Alternatively, magnets 205 may be disposed so that adjacent pole orientations are opposite each other. Magnetic insert 115 is preferably resilient, having a dimension and shape that includes contoured slotted edges. Preferably, the shape of the magnetic insert 115 is similar to, yet smaller than, chain link 110 so that the insert 115 may be removably attached to the chain link 110 by rotating and locking the magnetic insert 115 into a compression fit with chain link 110.

For example, as shown in FIG. 3, the insert 115 is shaped so that the minor axis of the chain link 110 is slightly less than the major axis of resilient insert 115. Rotation of the major axis of the insert 115 into the minor axis of the link 110 results in the aforementioned compression fit of the insert 115 with the link 110. Thus, the magnetic insert 115 may be formed like a grommet and should be composed of a moderately stiff yet resilient material, such as nylon, plastic, or rubber.

Alternatively, a copper clip (not shown) that passes through the axial hole of the magnet 205 may form a removable attachment to one side of the chain link 110 in order to provide user capability to dispose the magnet 205 in a desired position on the therapeutic collar 105.

Magnets 205 may be disposed symmetrically about the collar 105, beginning halfway between the large circular ends of the collar 105. Magnets 205 may be disposed on the collar 105 so that at least one chain link 110 not having a magnet insert 115 is interposed between chain links 110 having a magnet insert 115. Magnets 205 may be disposed on the collar 105 so that at least one chain link 110 not having a magnet insert 115 is interposed between an end of collar 105 and chain links 110 having a magnet insert 115. Any paramagnetic material, such as copper, may be used to attach the magnets 205. Additionally, a plurality of the magnets 205 may be attached to the collar 105 and disposed so that their polarities alternate, respectively.

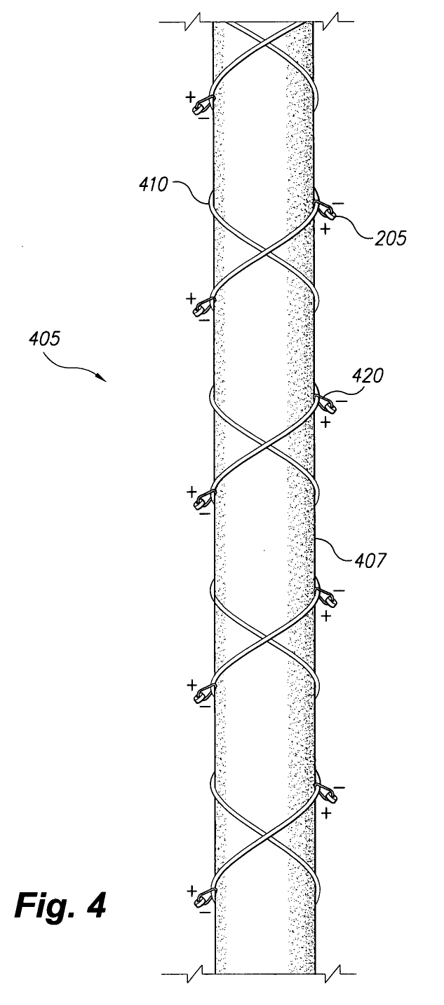

In an alternative embodiment, as shown in FIG. 4, a therapeutic collar 405 may be made from nylon, leather, or a combination of cloth type materials. A copper line 410 is braided in a crisscross pattern that spans approximately three-quarters of the length of the collar 405.

Magnets with an axial hole, such as magnets 205, may be disposed in a staggered manner on the copper line 410 towards the inside of the collar 405 facing perpendicular to the skin of pet P so that their polarities alternate respectively. Any predetermined number of magnets 205 may be utilized. The combination of copper and a magnetic field may stimulate improved blood circulation and toxin release. Additionally, the copper-magnetic field combination may enhance joint movements and relieve arthritis. A necklace worn by animal or human may be constructed in the same manner as the aforementioned alternative embodiment.

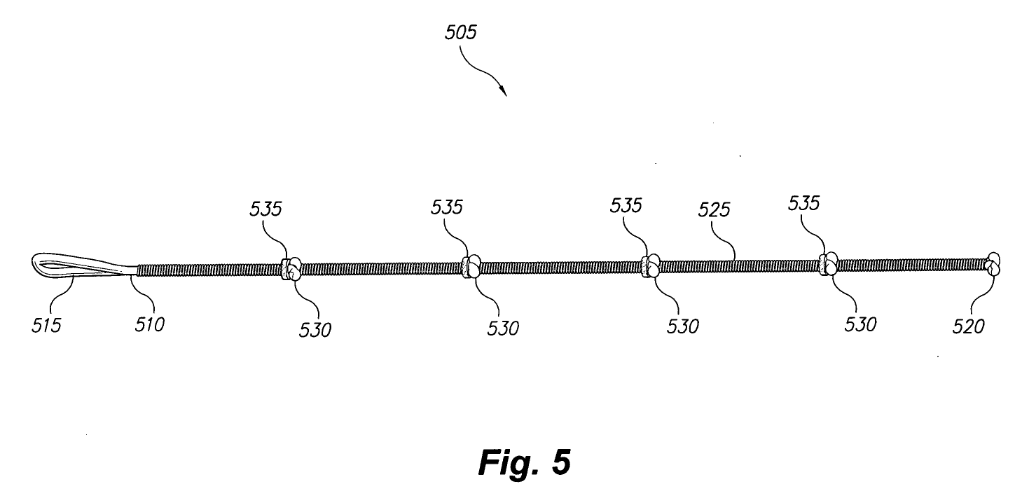

Alternatively, as shown in FIG. 5, a therapeutic necklace 505 may be fashioned from a leather string 510 having a loop 515 at one end and a terminating knot 520 on the opposite end. Copper wire 525 is wound around the leather string 510. A plurality of magnets are disposed on the copper-laden leather string 510. Each magnet 535 has an axial hole through which the leather string 510 is threaded. Each magnet 535 is retained on the string by an adjacent knot, such as supporting knots 530, tied on the string. Magnets 535 and supporting knots 530 are disposed along the length of the string at predetermined intervals, preferably one-inch intervals. Therapeutic necklace 505 may be worn as a collar by a smaller animal, such as a cat, or used as a necklace by a human.

It is to be understood that the present invention is not limited to the embodiments described above, but encompasses any and all embodiments within the scope of the following claims.

I claim:

1. A therapeutic pet collar, comprising:
a ferromagnetic metal chain collar having a plurality of links, the plurality of links being electroplated;
a plurality of resilient inserts, each insert including an attached magnet, each insert being lodged inside an individual link of the plurality of links.

2. The therapeutic pet collar according to claim 1, wherein the inserts are disposed in the links so that the magnets in adjacent pair of the inserts have opposite magnetic field orientations.

3. The therapeutic pet collar according to claim 1, wherein a predetermined number of the magnets are disposed in the links with identical magnetic field orientation.

4. The therapeutic pet collar according to claim 1, wherein the ferromagnetic metal comprises iron.

5. The therapeutic pet collar according to claim 1, wherein the ferromagnetic metal comprises nickel.

6. The therapeutic pet collar according to claim 1, wherein the electroplated links comprise about a 1/64^{th} inch copper layer deposited on the links.

7. The therapeutic pet collar according to claim 1, wherein the links are about ½ inch wide and vary in length by up to ⅝ inch.

8. The therapeutic pet collar according to claim 1, further comprising:
a spring-forced clasp and a first ring, the spring-forced clasp being attached to the first ring, the first ring being attached to an end link at a first end of the collar; and
a second ring attached to an end link at an opposing second end of the collar.

9. The therapeutic pet collar according to claim 1, wherein each of the magnets has a hollow, cylindrical shape having an axial hole for attaching the magnets to the inserts.

10. The therapeutic pet collar according to claim 1, wherein each of the magnets has a residual flux density rating between about twelve thousand Gauss and about thirteen thousand Gauss.

11. The therapeutic pet collar according to claim 1, wherein each of the inserts is a resilient body having contoured, slotted edges, the inserts having a shape corresponding to the chain links and smaller dimensions so that the inserts are removably attachable to the links by rotating and locking the inserts into a compression fit with the links.

12. The therapeutic pet collar according to claim 1, wherein the insert comprises a grommet made from a thermoplastic material.

13. The therapeutic pet collar according to claim 1, wherein the inserts grommets made from rubber.

14. The therapeutic pet collar according to claim 11, wherein each of the magnets has a hollow, cylindrical shape having an axial hole for attaching the magnets to the inserts, the therapeutic pet collar further comprising an axle having paramagnetic properties disposed through the axial hole of the magnets, opposing ends of the axle being can securely attached to the corresponding inserts.

15. The therapeutic pet collar according to claim 1, wherein the magnets are disposed symmetrically about the links of the collar.

16. The therapeutic pet collar according to claim 1, wherein the magnets are disposed on the collar links so that one of the links without one of the magnets is interposed between the links having one of the inserts with one of the magnets disposed therein.

17. The therapeutic pet collar according to claim 1, wherein the magnets are disposed on the collar so that a chain link without one of the magnets is interposed between an end of the link collar and one of the links having one of the magnets disposed herein.

18. The therapeutic pet collar according to claim 1, wherein the magnets are disposed on the link collar with opposite magnetic polarities are proximate a wearer's skin.

19. A therapeutic pet collar, comprising:
a flexible, non-metallic collar having a copper line braided over and under the collar in a crisscross pattern;
a plurality of magnets attached to the non-metallic collar. the magnets being attached at staggered attachment points on opposite sides of the copper line, adjacent pairs of the magnets having opposite magnetic field orientations.

20. A therapeutic necklace, comprising:
a leather string having a loop at one end and a terminal knot on an opposite end;
copper wire wound around the leather string; and
a plurality of magnets having axial holes defined therein, the copper wound string extending through the axial holes, the string having a knot adjacent each of the magnets for retaining the magnets' position on the string, the magnets being disposed along the string at predetermined intervals.
